(19) United States
(12) Patent Application Publication
(10) Pub. No.: US 2007/0157049 A1
(43) Pub. Date: Jul. 5, 2007

(54) Adjusting input output timing

(76) Inventors: Songmin Kim, Beaverton, OR (US); Gregory Taylor, Portland, OR (US); Peter MacWilliams, Aloha, OR (US)

Correspondence Address: TROP PRUNER & HU, PC, 1616 S. VOSS ROAD, SUITE 750, HOUSTON, TX, 77057-2631, US

(21) Appl. No.: 11/322,917

(22) Filed: Dec. 30, 2005

(51) Int. Cl. G06F 1/12

(52) U.S. Cl. 713/401

(57) ABSTRACT

The frequency of a bus with at least three agents is limited by both setup and hold timings between any two agents coupled to the bus. To adjust for the setup condition, the bus lengths between any two agents can be short. To adjust for the hold condition, the bus lengths can be long. Different amounts of delay can be built into the bus agents, such as processing cores, which are coupled to a bus with other agents, such other processors or a chipset. The position of an agent on the bus can be used to determine an amount of delay that can be included in the input and output paths of the agent after the semiconductor processing so that a violation of the setup or hold condition does not occur. The delay can be made configurable using links.

### BACKGROUND

This invention relates generally to single-package processors with at least two separate processing cores.

To achieve an increase in the frequency operation for a bus between agents on a bus, such as two processing cores and a chipset, the trace lengths between any two agents on the bus can be shortened. An agent can be a processing core or a chipset, or another device coupled to the bus. Shortening the trace lengths can satisfy the setup time requirements between all the agents on a bus. The bus agents can be connected in a daisy-chain topology, for example from a processing core to a second processing core and from the second processing core to a chipset. The inputs and outputs of the two end agents, for example a processing core and a chipset, can provide bus termination circuits that the other agents on the bus do not provide. A bus termination circuit can be resistors matching the effective impedance of the bus.

To avoid any timing violation caused by possible race conditions, however, the trace lengths between any two bus agents cannot be too short. A race condition occurs when data is sent from an agent on a bus and another agent on the bus receives the data before the agent is ready to receive the data, thus violating a hold time requirement. Placing the two processing cores close to each other on a single package can create such a hold time violation between the two cores. In a daisy-chain topology, the hold time requirement between the two processing cores can limit how short the overall bus length can be.

The trace length between an end agent and an intermediate agent can be increased to avoid the timing violation while maintaining the overall bus length between the agents at the end of a bus. This can result in a star topology, where there are at least three segments of traces originating from a location on the bus and connecting each agent to the bus. This can create a stub which branches off the main bus between the two end agents to connect the intermediate agent to the bus. This stub can cause ring-back due to an impedance mismatch at the branch-off point of the bus. When the voltage and current wave from one trace branch arrives at the branch-off point, it sees two traces in parallel which introduces inherent impedance mismatch. If a stub is unterminated, for example to maintain the same direct current (DC) operating condition as in the original daisy-chain topology bus, it can result in increased amounts of ring-back when the current that flows through the bus to an open circuit is reflected back into the bus. When ring-back is present, the frequency of the bus can be lowered to reduce the effects of ring-back. This can cause the bus and the system to operate at a slower frequency.

To reduce such ring-back and increase the bus frequency, all endpoints of a star topology bus can be terminated by a bus termination circuit. Additional termination circuits, however, reduce the direct current (DC) voltage range available for the bus operation and can result in less noise margin than the daisy-chain topology with the terminations at the two end points.

### BRIEF DESCRIPTION OF THE DRAWINGS

FIGS. 1A, 1B, and 1C are timing charts for one embodiment;

FIG. 2 is a schematic drawing of an embodiment of a processing core that can be configured after manufacturing;

FIG. 3 is a schematic drawing of an embodiment of a configurable delay line;

FIG. 4 is a schematic drawing of an embodiment of two processing cores coupled by a bus to a chipset;

FIG. 5 is a schematic drawing of an embodiment of a signal package component with multiple cores.

### DETAILED DESCRIPTION

In an embodiment the processing cores can have their own inputs and outputs coupled to a common electrical bus. A processing core or chipset can communicate with other agents through a common electrical bus. A package can hold processing cores and can comprise a bus to connect inputs and outputs of agents in the package and package pins. The bus in the package can be a trace. The package pins can connect to traces on the platform, such as a printed circuit board. The traces can connect the package pins to the chipset inputs and outputs to allow communication between the processing cores or agents in the package and a chipset. In one embodiment, the chipset can communicate with other subsystems in the platform such as system, memory, graphics, display, and/or other input output devices through separate inputs and outputs for each subsystem.

In order to increase the bus speed, the clock to output time of the driving agent,the flight time of the signal, and the setup time of the receiving agent can be reduced. The driving agent can be the agent that is sending data on a bus and the receiving agent can be an agent that is latching the data being sent. The clock to output time is the time between the common reference clock received by the driving agent and the new data appearing at the pin of the driving agent. The setup time is the least amount of time for the new data to be valid at the receiving agent before its clock edge for a successful data transfer to occur. The hold time is the time the new data must be valid at the receiving agent after a clock edge for a successful data transfer to occur. The data setup time plus the hold time can be called the valid data window. The flight time is the time a data signal takes to travel from one agent to another agent on a bus.

There is a limitation on how much clock to output time and data setup time can be reduced to reduce the overall timing between the processing core furthest from the chipset and the chipset on the bus. In some embodiments, both the difference between the minimum and maximum clock to output times, and the data setup time plus the hold time, are fixed. Reducing the clock to output time and the setup time can cause hold violations between two agents, for example between the two processing core agents which can be placed close to each other on a single processor package.

The bus's operating frequency can be increased by reducing the system clock period or the time to complete one cycle on the bus. The frequency may not be increased above a value that can result in the length of one cycle being less than the clock to output time plus the flight time plus the data setup time plus the clock skew plus the clock jitter. A setup requirement violation can occur at the receiving agent if the frequency is increased above this value. Clock skew is the time difference between the clock edges received at all agents on the bus, which can be caused by the differences in time for the clock signals to reach all bus agents from the clock generation chip or by the clock chip itself. Clock jitter can also be introduced by the clock chip itself or by board effects such as noises, creating a clock period of less than the intended value. For example, a clock with a period of 9.8 nanoseconds can occur in some clock cycles while the intended period is 10 nanoseconds. In this case a clock jitter of 0.2 nanoseconds can be subtracted from the period, and the bus can be designed for 9.8 nanoseconds to compensate for the clock jitter.

On the other hand, to avoid hold violations the clock to output time of the driving agent plus the flight time has to be greater than the hold time of the receiving agent plus the clock skew. Reducing the maximum clock to output time and the setup time can reduce the minimum clock to output time and increase the hold time making it more difficult to meet the hold requirement.

For data transmitted from one agent to appear at other agents in the valid data window, the following variables can be considered for both hold and setup cases: the setup time, the hold time, the clock skew, the clock jitter, the flight time, and the minimum and maximum clock to output time.

A delay can be added to the input and output paths of the agents on the bus to increase the clock to output time, to increase the setup time and to decrease the hold time. Delay lines can be used to meet these timing requirements between two agents on a bus. In one embodiment, a delay line can be a series of gates comprising transistors. A delay line can be created with a delay amount that can be digitally controlled. For example, a delay line can be created to adjust from no delay through sixteen or more levels of delay elements.

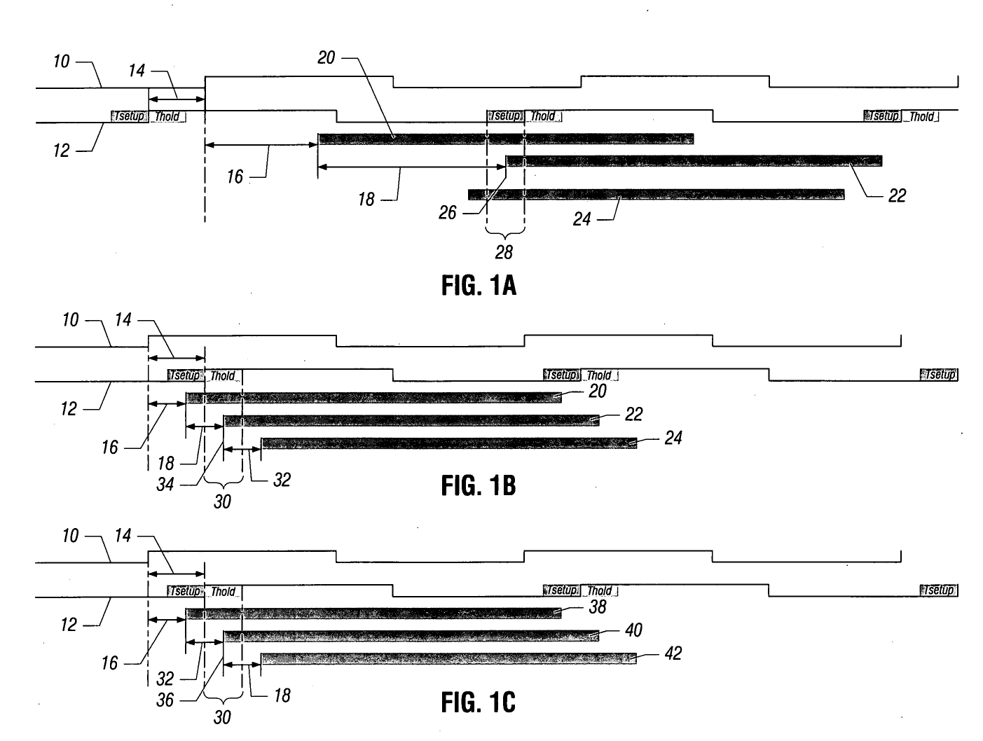

With reference to the figures, FIG. 1A, FIG. 1B, and FIG. 1C represent hypothetical timing charts between two agents on a bus. The agents can be a processing core, a chipset or another component.

FIG. 1A represents the timing between two agents at opposite ends of the same bus. Adding a delay to the input or output paths of either of these agents can cause the speed of the bus to decrease.

FIG. 1A depicts a hypothetical representation of a violation of a setup time, Tsetup. The clock signal 10 represents the clock at the driving agent. The clock signal 12 represents the clock at a receiving agent. The clock signals 10 and 12 are shifted by the clock skew 14. The clock to output time 16 begins at the,clock edge of clock signal 10 at the driving agent and ends with the beginning of new data 20 appearing on the bus at the driving agent. The time that the new data takes to travel from the driving agent to the receiving agent is the flight time 18. New data 22 at the receiving agent is received at a time 26 during the setup time 28, setup. A data transition occurring inside the setup window 28 can cause problems because the wrong data can be latched by the receiving agent. If the speed of the bus is increased, the flight time 18 can be reduced and new data 24 can be received before the data setup window 28, Tsetup.

FIG. 1B depicts a hypothetical timing chart representing data sent between two agents that can be located close together on a bus. The driving agent in this hypothetical example is the end agent of a bus. A delay line can be added to the input path of the receiving agent to prevent a violation of the hold time, Thold. Adding a delay to the output path of the driving agent can result in reducing the frequency of the bus.

FIG. 1B depicts a hypothetical clock signal representing what can happen if the speed of the bus is increased beyond the minimum requirement. When two agents on a bus are located close together, increasing the speed of the bus can cause new data to arrive at a receiving agent before it is expected. The clock signal 10 represents a clock at a driving agent. The clock signal 12 represents a clock at a receiving agent. The clock signals 10 and 12 are shifted by clock skew 14. The clock to output time 16 begins at the edge of clock 10 and ends when new data 20 appears at the driving agent. The flight time 18 begins when the new data 20 appears on the bus at the driving agent and ends when new data 22 appears on the bus at the receiving agent. The new data 22 arrives at a time 34 within the data hold window 30, Thold. A transition of data at time 34 within the hold window 30 can cause the wrong data to be latched by the receiving agent. Adding a delay 32 to the input path of the receiving agent can result in new data 24 arriving at the latch of the receiving agent after the Hold window 30, Thold. The added delay 32 can prevent the new data 20, sent from the driving agent, from being latched improperly at time 34 by a receiving agent.

FIG. 1C depicts a hypothetical clock signal representing what can happen if the speed of the bus is increased beyond the minimum requirement. When two agents on a bus are located close together, increasing the speed of the bus can cause new data to arrive at a receiving agent before it is expected. In FIG. 1C, the receiving agent is the end agent on a bus. A delay can be added to the output path of the driving agent so that a hold violation cannot occur at the receiving agent. A delay is not added to the input path of the receiving agent because adding a delay to the end agent of a bus can result in a decrease in the frequency of the bus.

FIG. 1C depicts a hypothetical timing chart representing a hold violation. A clock signal 10 represents a clock at a driving agent. The clock signal 12 represents the clock at a receiving agent. The clock signals 10 and 12 are shifted by clock skew 14. The clock to output time 16 begins at the clock edge of the driving agent and ends when new data 38 appears at the driving agent. By adding a delay 32 to the output path of the driving agent, the new data 40 can appear on the bus at the driving agent at time 36. The flight time between the driving agent and the receiving agent begins at the end of the delay time 32 and ends when new data 42 is received at the receiving agent. If the delay time 32 was not added to the output path of the driving agent, the flight time 18 can begin at the end of the clock to output time 16. This can cause the new data 40 sent by the driving agent to be received at the receiving agent at a time 36 within the hold window 30, Thold. A transition of data at time 36 within a hold window 30, Thold, can cause the wrong data to be latched by the receiving agent. If a delay 32 is added to the output path of the driving agent, the new data 42 at the receiving agent is received after the flight time 18 and outside the hold window 30, Thold.

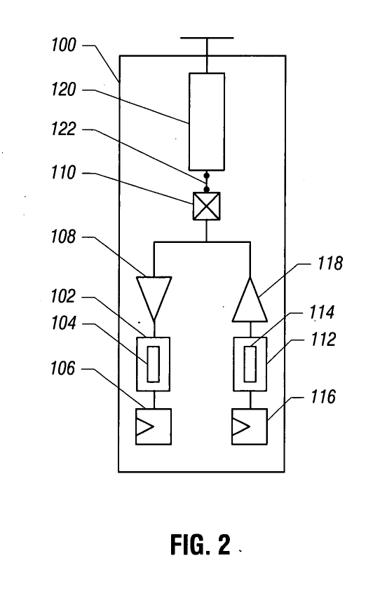

FIG. 2 depicts an embodiment of a processing core 100 configurable after semiconductor processing. The processing core 100 is depicted with components to illustrate one embodiment but additional components can be included.

The bus connection terminal 110 may couple to a bus termination circuit 120, input sense amplifier 108, and output driver 118. The bus termination circuit 120 can be deactivated by the link 122 when the bus connection terminal 110 of the processing core 100 is not located at the end of a bus. A link is a circuit component that is designed to allow modifications after semiconductor processing. For example, the link can be a fusible connection that burns off when a relatively high current is applied. The link can also be a software-controlled circuit component which can be configured to be either an open or a short circuit.

The processing core 100 can comprise configurable delay lines 102 and 112. The configurable delay line 102 can be located in the input path of processing core 100 between the input sense amplifier 108 and the input latch 106. Link 104 can be used to adjust the amount of delay in the delay line 102. Input latch 106 can store data received from the bus connection terminal 110 through the sense amplifier 108. The input sense amplifier 108 senses the input voltage on the bus and outputs a digital signal to the input latch 106.

The configurable delay line 112 can be located in the output path of the processing core 100 between the output latch 116 and the output driver 118. Output latch 116 can store data that is waiting to be output to the bus through the output driver 118. The output driver 118 senses the data in the output latch 116 and amplifies the signal for transmission on a bus. The configurable delay lines 102 and 112 can include different amounts of delay that can be adjusted using links 104, 114.

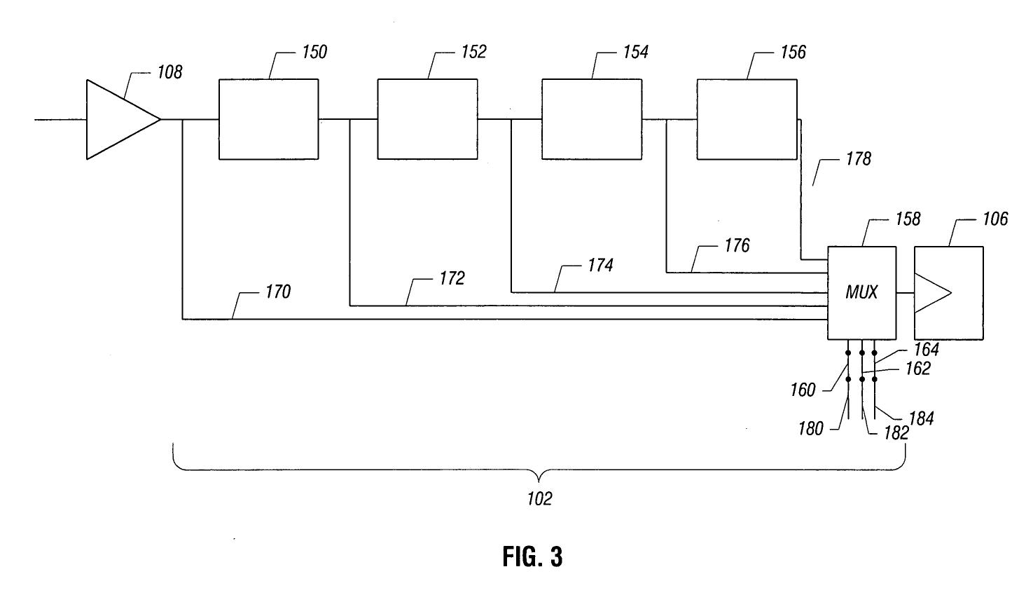

FIG. 3 depicts an embodiment of a configurable delay line 102. The delay line 112 may be of identical design to the line 102 in some embodiments. The configurable delay line 102 can include delay elements 150, 152, 154, and 156. In one embodiment the delay elements 150, 152, 154, and 156 are connected in series. The delay elements can be transistors, gates, or any components that can delay a signal. Connected between the delay elements can be bypass paths 170, 172, 174, 176, and 178. The bypass paths 170, 172, 174, 176, and 178 can connect to a multiplexer 158. The multiplexer selection inputs 180, 182, and 184 can include links 160, 162, and 164.

In this embodiment, the links 160, 162, 164 can be connected or disconnected to select paths 170, 172, 174, 176, or 178 depending on the appropriate amount of delay to be added to an input or output path. Although four delay elements 150, 152, 154 and 156, five bypass paths 170, 172, 174, 176, and 178, and three links 160, 162, and 164 are depicted as one embodiment in FIG. 3, there can be more or fewer delay elements, delay paths, and links which can give a higher or a lower number of selectable delay amounts.

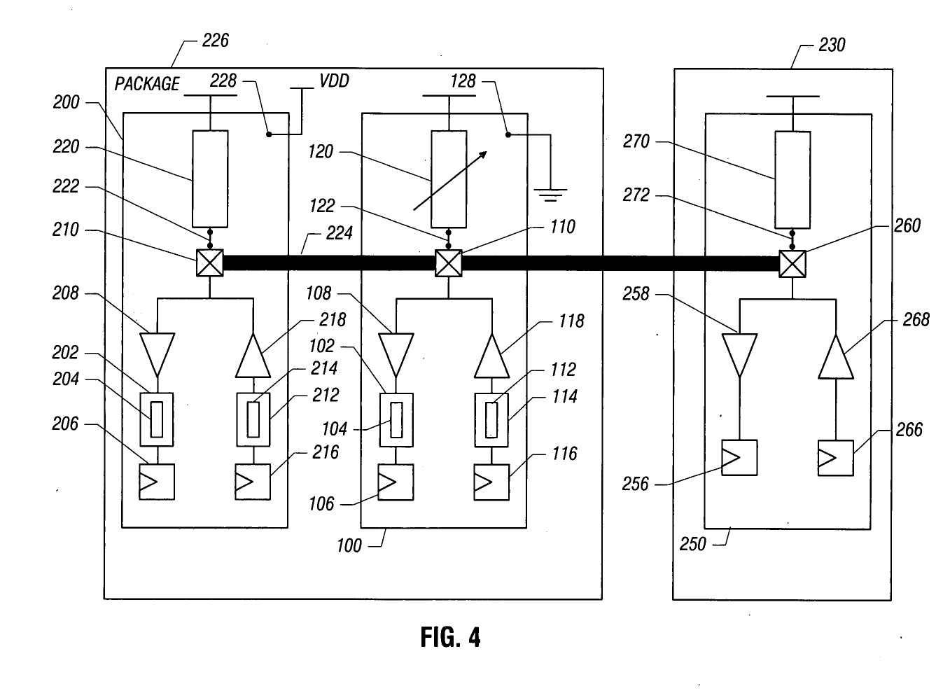

FIG. 4 depicts an embodiment of two processing cores 100 and 200 within an integrated circuit package 226, which is connected by a bus 224 to a chipset 250 in an integrated circuit package 230. The processing cores 100 and 200 can communicate with each other as well. The bus length between the packages 226 and 230 can be longer than the bus length between the processing cores 100 and 200.

Within the processing cores 100 and 200 and the chipset 250 are bus termination circuits 120, 220, and 270. The bus termination circuits 120, 220, and 270 can be coupled to the bus 224 at the bus connection terminals 110, 210, and 260 with links 122, 222, and 272. Also coupled to the bus 224 at the bus connection terminals 110 and 210 for the processing cores 100 and 200 are sense amplifiers 108 and 208 and output drivers 118 and 218. The delay lines 102 and 202 connect the input sense amplifiers 108 and 208 to the input latches 106 and 206. The delay lines 112 and 212 connect the output drivers 118 and 218 to the output latches 116 and 216. The chipset 250 may also include input sense amplifiers 258, input latches 256, output drivers 268, and output latches 266. The processing cores 100 and 200 and the chipset 250 are depicted with components to illustrate one embodiment but the processing cores 100 and 200 and the chipset 250 can include additional components.

The semiconductor manufacturing cost can be reduced in one embodiment by manufacturing all processing cores from masks with approximately the same layout for the processing core 100 and 200, and then using links to turn different circuit components off or on to create multiple configurations of the processing cores based on their locations within the processor package.

The location of the processing cores 100 and 200 within package 226 can be determined after the processing cores are manufactured. In an embodiment, the location of a processing core within the package 226 can be detected by the processing core itself by the state of a pin 128 or 228 on a processing core 100 or 200 respectively. After the processing cores 100 and 200 are installed in a package 226, the package 226 can be designed to pull the package pins 128 and 228 to ground or supply voltage rail, for example. Each processing core can have an internal logic circuit to read the package pins 128 and 228 and determine which components remain active. For example, when the package pin 128 is pulled to ground as shown in the figure, the logic can turn off bus termination circuit 120 and a delay can be set in the input and output path delay lines 102 and 112. The delay lines 102 and 112 can be adjusted to avoid the possibility of hold timing problems between the processing core 100 and processing core 200 on bus 224.

The amount of delay can be determined by the location of the processing core 100 in relation to the processing core 200. In one embodiment, the amount of the delay to be added to the processing core 100 can be approximately the same as the flight time of the bus between terminals 210 and 110 of the two processing cores as shown in FIG. 4.

When pin 228 is pulled to supply voltage rail, for example in the processing core 200 which is at the end of a bus, the signal delay can be minimized in the input output paths to increase the frequency of the bus 224.

To create a bus that can reduce the hold time risk between processing core 100 and processing core 200 without reducing the bus frequency, delay lines 102, 112, 202, and 212 can be adjusted in the input and output paths of the processing cores between the input and output latches 106, 116, 206, and 216 and the bus 224. The delay lines 102, 112, 202, and 212 can create different delay lengths to compensate for the relative location of the processing core along the bus 224.

The delay line 102 can be adjusted using links 104 to increase or decrease the delay between the input latch 106 and the bus connection 110. The links 104 can be added or broken to increase or decrease the amount of delay created by gates and transistors in the delay lines. In one embodiment, the delay line 112 can be adjusted-to increase the delay between the output latch 116 and the bus connection terminal 110. The increased delay from the input and output latches 106 and 116 to the bus connection terminal 110 can increase the time that it takes to transmit data between processing core 100 and processing core 200. The increase in time allows data to be valid at a time corresponding to the receipt of a clock signal.

Although only two processing cores, processing core 100 and processing core 200, are depicted, additional processing cores can be used as well. The additional processing cores can include delay lines tuned to maintain the frequency of the bus 224 while creating a delay between the processing cores 100 and 200 so that data sent between the processing cores appears in the valid data window.

In one embodiment, timing measurements can be used after the semiconductor manufacturing to determine the optimal amount of delay to be added to the input and output paths of the processing core 100. This amount can depend on the relative locations of the two processing cores within the package 226. The manufacturing process can result in variation of delay per delay element for each processed core due to manufacturing process variation, and the post-semiconductor testing can compensate for such variation.

For example, a timing tester placed at the bus connection terminals 110 and 210 of processing cores 100 and 200 can record the clock to output time, the input times, and the setup and hold times of both processing cores. Then, the delay lines 102, 112, 202, and 212 of processing cores 100 and 200 can be adjusted so that the clock to output and setup times of the two cores is matched at the processor package pins when the processing cores are different distances from the package pins. The package pins can be used to connect the package 226 to a printed circuit board, a cable or another electrical connector. The adjustment of the delay lines 102, 112, 202, and 212 can be an automated process, and the adjustment can take place right after the semiconductor processing is complete.

In another embodiment, a timing test can be done after the two cores have been packaged into a package 226. A timing tester can be placed at a package 226 pin and can record two sets of input and output timings, one set when driven by the processing core 100 and another set when driven by the processing core 200. The delay lines 102, 112, 202, and 212 can be configured such that the two sets of timings are matched. For example, the clock to output timing when driven by the processing core 100 can be adjusted to be similar to the clock to output timing when driven by the processing core 200 in a single package.

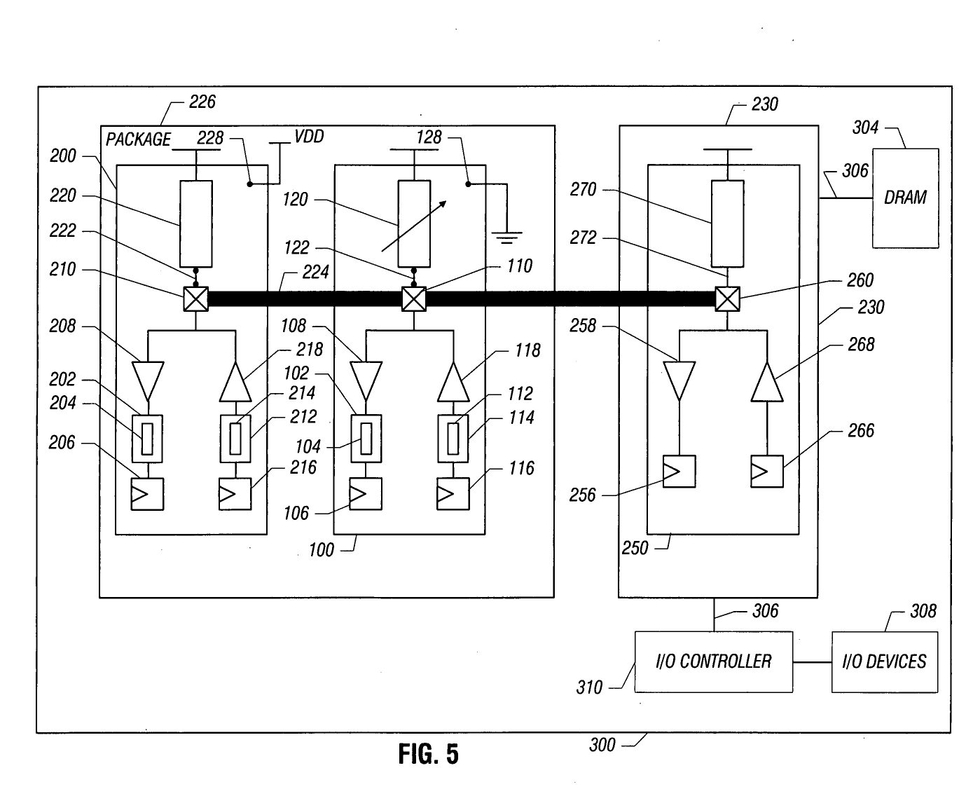

FIG. 5 depicts an embodiment of a part of a computer 300. The computer 300 can include a processor package 226, a chipset package 230, an input output controller 310, and a dynamic random access memory module (DRAM) 304. The package 226 can include two processing cores 100 and 200 and a bus 224. The bus 224 can couple package 226 to package 230 including a chipset 250. The chipset 250 located in the package 230 can be coupled to an external data bus 306. The external data bus 306 can be coupled to additional components that are not included in the package. The additional components can be memory such as dynamic random access memory (DRAM) 304, or an input output controller 310. The input output controller 310 can couple the input output devices 308 to the chipset 250 in package 230. The input output devices 308 can be a hard drive, a graphics card, or another input or output component. A dynamic random access memory can store information in integrated circuits that include capacitors that can be refreshed to preserve the stored data. The components in the package 226 can send data to and receive data from the dynamic random access memory by a bus between the package and the dynamic random access memory. A chipset 250 can send and receive data stored in the dynamic random access memory 304 along a second bus 306. The chipset can distribute the data to the processing cores 100 and 200 depending on the operations of the processing cores 100 and 200 and the chipset 250. The data received from the dynamic random access memory can be transmitted from the chipset 250 to the processing cores 100 and 200. The delay lines 102, 112, 202, and 212 in the processing cores 100 and 200 allow the data to be received from the chipset or a processing core by the other processing core during the valid data window.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
determining a location of a first of at least two agents on a bus; and
adjusting an adjustable delay for said first agent based on the location of said first agent.

2. The method of claim 1 including packaging said first and a second agent in the same package.

3. The method of claim 2 including adjusting an amount of delay according to the location of the first agent within the package.

4. The method of claim 2 including determining the state of a package pin to indicate the location of the first agent in the package.

5. The method of claim 1 including adjusting the adjustable delay using configurable links.

6. The method of claim 1 including adjusting the delay after packaging the first agent.

7. The method of claim 1 including adjusting the time to transmit data between two processing cores.

8. The method of claim 7 including adjusting the delay to enable data to be valid upon receipt of a clock signal.

9. A device comprising:
a processing core including an input path and an output path;
a delay line in at least one of the input path and the output path; and
a link in the delay line to alter the amount of signal delay.

10. The device of claim 9 including at least two processing cores coupled by a bus.

11. The device of claim 10 including a package, said processing cores contained in said package.

12. The device of claim 11, said link being configurable to alter the length of signal delay based on the location of a core within the package.

13. The device of claim 11 including logic to alter the length of signal delay based on the location of at least one of the at least two processing cores within the package.

14. The device of claim 11 including a pin to indicate the location of at least one of the at least two processing cores in the package.

15. A device comprising:
at least two bus agents that have input and output paths;
a delay line in at least one of the input path and the output path; and
a configurable link in the delay line to alter the amount of signal delay.

16. The device of claim 15 including a package to hold the at least two bus agents.

17. The device of claim 16 wherein the link is adjustable to enable the length of signal delay to be adjusted based on the location of at least one of the at least two bus agents within the package.

18. The device of claim 16 including logic to adjust the length of signal delay based on the location of at least one of the at least two bus agents within the package.

19. The device of claim 16 including a pin to indicate the location of at least one of the at least two bus agents in the package.

20. The device of claim 15 wherein said bus agents are processing cores.

21. The device of claim 20 including a chipset and bus coupling said chipset to said cores.

22. A system comprising:
at least two processing cores that have input and output paths;
a bus coupled to said cores through said input and output paths;
a delay line in at least one of the input and output paths;
a configurable link in the delay line to adjust the amount of signal delay; and
dynamic random access memory (DRAM) coupled to at least one of said processing cores.

23. The system of claim 22 including a package to hold the at least two processing cores.

24. The system of claim 23, said link to enable adjustment of the length of signal delay based on the location of at least one of the at least two processing cores within the package.

25. The system of claim 23 including a pin to indicate the location of at least one of the at least two processing cores in the package.

26. The system of claim 22 including a chipset, said bus coupling said chipset and said cores.
